(19) United States
(12) Patent Application Publication
(10) Pub. No.: US 2026/0138547 A1
(43) Pub. Date: May 21, 2026

(54) CONTROL DEVICE

(71) Applicant: TOYOTA JIDOSHA KABUSHIKI KAISHA, Toyota-shi Aichi-ken (JP)

(72) Inventor: Yoshiyuki TAKAHARA, Toyota-shi Aichi-ken (JP)

(73) Assignee: TOYOTA JIDOSHA KABUSHIKI KAISHA, Toyota-shi Aichi-ken (JP)

(21) Appl. No.: 19/389,290

(22) Filed: Nov. 14, 2025

(30) Foreign Application Priority Data
Nov. 18, 2024 (JP) 2024-200347

(51) Int. Cl. B60R 16/033; B60L 58/12; G07C 5/08; H01M 10/42; H01M 50/249; H02J 7/00

(52) U.S. Cl. CPC B60R 16/033; H01M 10/425; H01M 50/249; H02J 7/94; H02J 7/977; B60L 58/12; B60L 2240/545; G07C 5/0808; H01M 2220/20

(57) ABSTRACT

A control device configured to control an auxiliary battery mounted on a vehicle includes: a first processing unit setting an allowable charging current of the auxiliary battery based on a state of the vehicle and a state of the auxiliary battery; and a second processing unit controlling charging of the auxiliary battery based on the allowable charging current.

### CROSS-REFERENCE TO RELATED APPLICATION

This application claims priority to Japanese Patent Application No. 2024-200347 filed on Nov. 18, 2024. The disclosure of the above-identified application, including the specification, drawings, and claims, is incorporated by reference herein in its entirety.

### BACKGROUND

### 1. Technical Field

The present disclosure relates to a control device that controls a battery mounted on a vehicle.

### 2. Description of Related Art

Japanese Unexamined Patent Application Publication No. 2021-068637 (JP 2021-068637 A) discloses a charging control device that prevents, when a battery configured of a lithium ion battery is charged, metallic lithium from depositing on a negative electrode of the lithium ion battery. JP 2021-068637 A describes that this charging control device calculates an allowable charging current based on a state (a current, a temperature, or an SOC) of the battery, and charges the battery based on this allowable charging current.

### SUMMARY

When the allowable charging current of the battery is calculated based on only the state (the current, the temperature, or the SOC) of the battery, there is a possibility that a charging current that actually flows through the battery exceeds the allowable charging current due to fluctuations of a load connected to the battery (a change in power consumption). When the charging current of the battery exceeds the allowable charging current, lithium deposition (Li deposition) occurs.

The present disclosure provides a control device capable of preventing lithium deposition from occurring in a battery even when a load connected to the battery fluctuates.

A first aspect of the present disclosure relates to a control device configured to control an auxiliary battery mounted on a vehicle. The control device includes: a first processing unit setting an allowable charging current of the auxiliary battery based on a state of the vehicle and a state of the auxiliary battery; and a second processing unit controlling charging of the auxiliary battery based on the allowable charging current.

The control device according to the first aspect of the present disclosure may include: a third processing unit reducing and resetting the allowable charging current when an actual charging current actually flowing through the auxiliary battery exceeds the allowable charging current; and a fourth processing unit determining that an abnormality has occurred in charging control when the actual charging current exceeds the reset allowable charging current continuously for a predetermined time.

In the control device according to the first aspect of the present disclosure, the state of the auxiliary battery may include a temperature of the auxiliary battery and a capacity retention rate of the auxiliary battery. The first processing unit may set the allowable charging current according to the temperature of the auxiliary battery and the capacity retention rate of the auxiliary battery.

In the control device according to the first aspect of the present disclosure, the state of the vehicle may include whether or not the vehicle is parked. The first processing unit may set, in a case other than when the vehicle is parked, the allowable charging current to be smaller than a case in which the vehicle is parked.

A second aspect of the present disclosure relates to a control device configured to control an auxiliary battery mounted on a vehicle. The control device includes: a first processor configured to set an allowable charging current of the auxiliary battery based on a state of the vehicle and a state of the auxiliary battery; and a second processor configured to control charging of the auxiliary battery based on the allowable charging current.

With the control devices of the first aspect and the second aspect, the allowable charging current is adjusted according to the state of the vehicle and the state of the auxiliary battery, and hence, even when the load connected to the battery fluctuates, it is possible to prevent lithium deposition from occurring in the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a load and a power supply system including a control device according to one embodiment of the present disclosure;

FIG. 2 is a process flowchart of auxiliary battery charging control executed by the control device;

FIG. 3 is an example of a two-dimensional map for deriving an allowable charging current; and

FIG. 4 is a timing chart illustrating a change of each state in the auxiliary battery charging control.

### DETAILED DESCRIPTION OF EMBODIMENTS

A control device of the present disclosure prevents lithium deposition caused by a charging current generated at the time of load fluctuations according to a state of a vehicle by adjusting an allowable charging current based on not only a state of an auxiliary battery but also the state of the vehicle.

Hereinafter, an embodiment of the present disclosure will be described in detail with reference to the drawings.

### EMBODIMENT

### Configuration

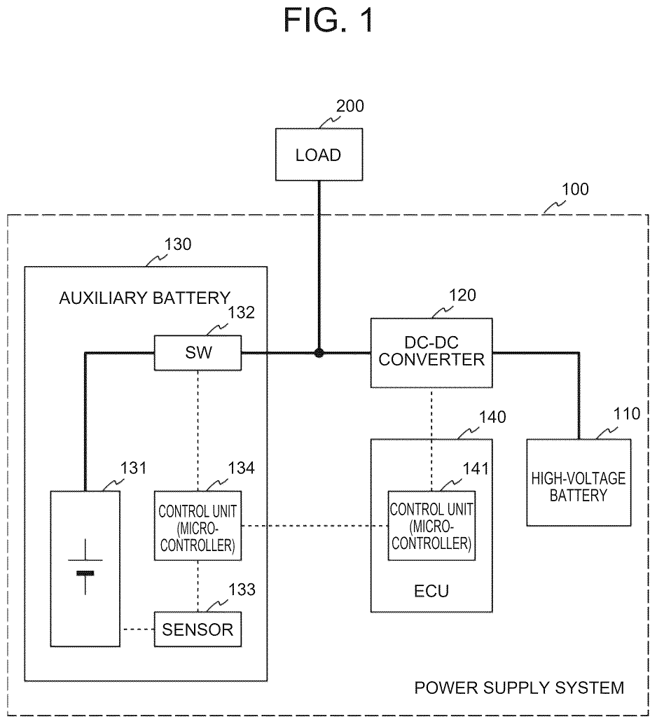

FIG. 1 is a diagram illustrating a schematic configuration of a power supply system 100 including a control device according to one embodiment of the present disclosure, and a load 200 that receives supply of electric power from the power supply system 100. The power supply system 100 exemplified in FIG. 1 includes a high-voltage battery 110, a DC-DC converter 120, an auxiliary battery 130, and an ECU 140. In FIG. 1, a wire through which electric power flows is indicated by the thick line, and a wire through which a detection signal, a control signal, and the like flow is indicated by the dotted line.

The configuration illustrated in FIG. 1 can be mounted on, as an example, an electrified vehicle such as a battery electric vehicle (BEV).

The high-voltage battery 110 is, for example, a secondary battery configured to be chargeable and dischargeable, such as a lithium ion battery. The high-voltage battery 110 can supply electric power stored therein to the auxiliary battery 130 and the load 200 via the DC-DC converter 120. Further, the high-voltage battery 110 can store electric power output from a power generator (not shown) such as an alternator. In the electrified vehicle, for example, a driving battery corresponds to the high-voltage battery 110.

The DC-DC converter 120 is an electric power converter that is provided between the high-voltage battery 110 and the auxiliary battery 130, and converts electric power of the high-voltage battery 110 received as input into electric power having a voltage required for the auxiliary battery 130 or the load 200 to output the electric power. As the DC-DC converter 120, for example, a step-down DC-DC converter that steps down the voltage of the high-voltage battery 110 to output the voltage to the auxiliary battery 130 or the load 200 can be used.

The auxiliary battery 130 is, for example, a secondary battery configured to be chargeable and dischargeable, such as a lithium ion battery. The auxiliary battery (auxiliary LiB) 130 stores electric power output from the high-voltage battery 110 via the DC-DC converter 120, or supplies electric power stored therein to the load 200. The auxiliary battery 130 of this embodiment is formed as a control unit including a battery 131, a switch (SW) 132, a sensor 133, and a control unit 134 in the configuration.

The battery 131 is, for example, an assembled battery configured by connecting a plurality of battery cells in series and/or in parallel. The switch 132 is a switch element capable of switching an electrical connection state (conduction/disconnection) between the battery 131 and each of the DC-DC converter 120 and the load 200. The connection state of the switch 132 is switched through control of the control unit 134. A semiconductor relay or the like is used as the switch 132. The sensor 133 is a device that detects a state (a voltage, a current, a temperature, or the like) of the battery 131. A voltage sensor, a current sensor, a temperature sensor, or the like is used as the sensor 133. The control unit 134 is a configuration provided to monitor and control the state of the auxiliary battery 130, and is, for example, a microcontroller (an arithmetic microcontroller) or at least one processor. One processor of the control unit 134 may perform the first to fourth processes described below. Alternatively, multiple processors of the control unit 134 may respectively perform the first to fourth processes. The control unit 134 performs, for example, processing of acquiring the state of the battery 131 from the sensor 133, and setting an input current (hereinafter referred to as an “allowable charging current of the auxiliary battery 130”) allowable when the battery 131 is charged, based on the state of the battery 131 and a state of the vehicle acquired from predetermined in-vehicle equipment or the like (not shown).

The ECU 140 is an electronic control unit that controls electric power transfer between the high-voltage battery 110 and the auxiliary battery 130. The ECU 140 includes a control unit 141 that controls the DC-DC converter 120 in the configuration. The control unit 141 is, for example, a microcontroller (an arithmetic microcontroller) or at least one processor. The control unit 141 performs, for example, processing of controlling an output voltage of the DC-DC converter 120 according to an allowable charging current given as a notification from the control unit 134 of the auxiliary battery 130. The control unit 141 of the ECU 140 and the control unit 134 of the auxiliary battery 130 are connected so as to be communicable to each other via an in-vehicle network such as a controller area network (CAN) or a direct wire.

The load 200 is in-vehicle equipment (an auxiliary load) that operates with the use of electric power supplied from the high-voltage battery 110 via the DC-DC converter 120 and/or electric power supplied from the auxiliary battery 130. The number of loads 200 that receive supply of electric power from the power supply system 100 is not limited to one. Further, a connection mode between the power supply system 100 and the load 200 is not limited to the one illustrated in FIG. 1, and it is also possible to employ a mode in which the load 200 is connected to the power supply system 100 (the DC-DC converter 120 or the auxiliary battery 130) via one or more switches, an ECU, or the like.

The control device according to one embodiment of the present disclosure is a configuration including the control unit 134 of the auxiliary battery 130 and the control unit 141 of the ECU 140. It is to be noted that FIG. 1 shows an example in which the control unit 134 and the control unit 141 are configured as separate members, but the control unit 134 and the control unit 141 may be configured integrally.

### Control

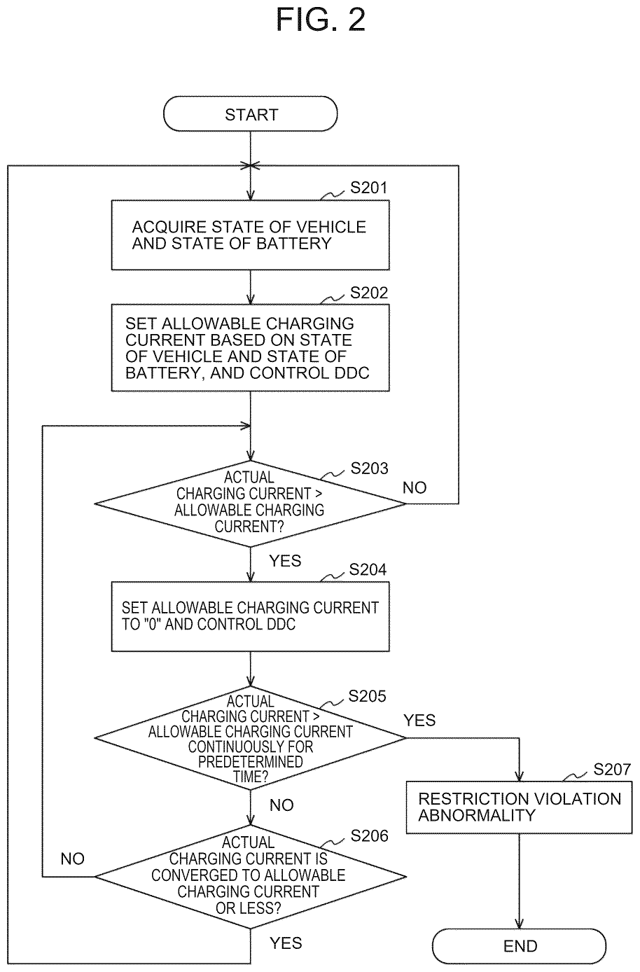

Next, further with reference to FIG. 2, control performed by the control device according to one embodiment of the present disclosure will be described. FIG. 2 is a flowchart illustrating a process procedure of auxiliary battery charging control executed by the control unit 134 of the auxiliary battery 130 and the control unit 141 of the ECU 140 configuring the control device.

The auxiliary battery charging control exemplified in FIG. 2 is started when a charging request for the auxiliary battery 130 with the electric power of the high-voltage battery 110, such as power-transfer charging, is generated.

### Step S201

The control unit 134 of the auxiliary battery 130 acquires the state of the vehicle (a vehicle power supply state) and the state of the battery 131. Specifically, the control unit 134 acquires a state of whether or not the vehicle is parked as the state of the vehicle, from predetermined in-vehicle equipment (not shown). Further, the control unit 134 acquires the temperature of the battery 131 as the state of the battery 131 from the sensor 133.

When the parking state of the vehicle and the temperature of the battery 131 are acquired by the control unit 134, the process proceeds to step S202.

### Step S202

The control unit 134 of the auxiliary battery 130 sets an allowable charging current of the auxiliary battery 130 based on the state of the vehicle and the state of the battery 131 (a first process). Specifically, the control unit 134 sets the allowable charging current of the auxiliary battery 130 based on whether or not the vehicle is in a state of being parked, the temperature of the battery 131, and a capacity retention rate (an estimated value) of the battery 131. In this embodiment, an upper limit value of a current input to the battery 131 that may cause lithium deposition is set as the allowable charging current. Further, the capacity retention rate of the battery 131 is a value indicating a ratio of a full charge capacity of the battery 131 in the current auxiliary battery 130 that has been deteriorated over time to a full charge capacity (100%) of the battery 131 at the time when the auxiliary battery 130 is new. It is to be noted that the full charge capacity can be calculated with the use of a well-known method (elapsed time mapping, a current integration method, or the like).

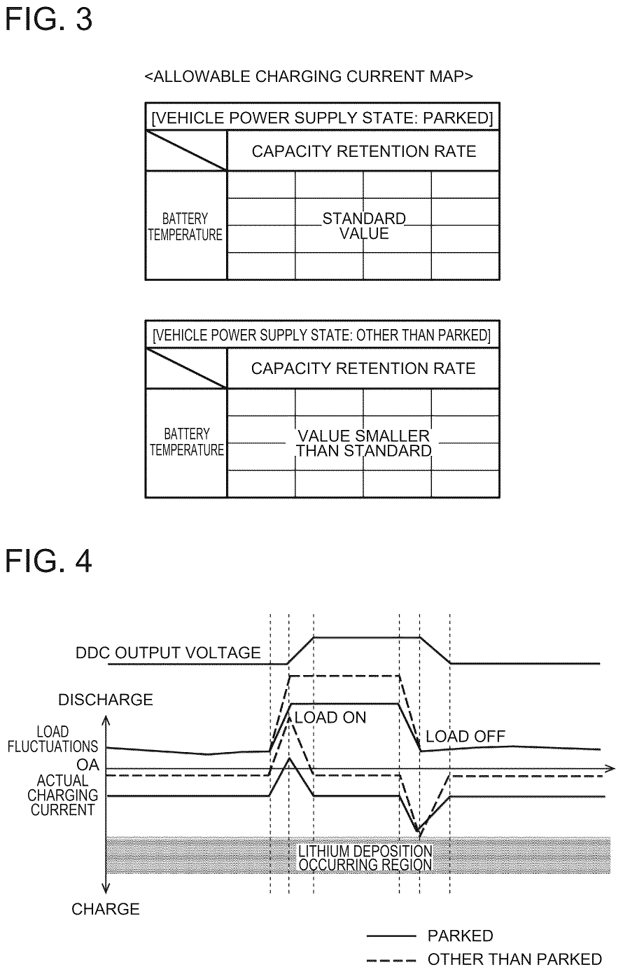

An example of a method of deriving the allowable charging current to be set is a method of using a two-dimensional map determined in advance based on a correspondence between the temperature of the battery 131 and the capacity retention rate of the battery 131. FIG. 3 shows an example of the two-dimensional map for deriving the allowable charging current of the auxiliary battery 130.

FIG. 3 shows an example in which two-dimensional maps having different values of allowable charging currents are prepared for two cases, that is, a case in which the state of the vehicle (the vehicle power supply state) is parked, and a case in which the state of the vehicle (the vehicle power supply state) is other than parked. In this case, the allowable charging current of the two-dimensional map in the case other than when the vehicle is parked is set to be smaller (a value smaller than standard) than the allowable charging current (a standard value) of the two-dimensional map in the case in which the vehicle is parked. The reason is as follows. In a state other than being parked (such as during travel) in which the load 200 may more greatly fluctuate as compared with the state of being parked (such as during electric power transfer), a charging current to the auxiliary battery 130 when the operation of the load 200 is turned off is also increased. This change of the charging current is caused because the amount of current consumed by the load 200 when the operation is on is used for charging of the auxiliary battery 130 when the operation is off (see FIG. 4). In view of the above, in order to prevent the charging current that increases along with the turning off of the operation of the load 200 from reaching a lithium deposition occurring region, the allowable charging current of the auxiliary battery 130 to be set is decreased when the vehicle is in a state other than being parked.

When the allowable charging current of the auxiliary battery 130 is set, the control unit 134 notifies the control unit 141 of the ECU 140 of the information regarding the allowable charging current. In response to this notification, the control unit 141 adjusts the output voltage of the DC-DC converter (DDC) 120 so that the charging current of the auxiliary battery 130 does not exceed the allowable charging current, and controls the current at the time of supplying electric power from the high-voltage battery 110 to the auxiliary battery 130 (a second process).

When the control unit 134 sets the allowable charging current of the auxiliary battery 130 based on the state of the vehicle and the state of the battery 131, and the control unit 141 controls the DC-DC converter 120 according to the allowable charging current, the process proceeds to step S203.

### Step S203

The control unit 134 of the auxiliary battery 130 determines whether or not a charging current actually flowing through the auxiliary battery 130 (hereinafter referred to as an “actual charging current”) exceeds the allowable charging current. This determination is made to check whether or not the charging control of the auxiliary battery 130 based on the allowable charging current is operated normally.

When the control unit 134 determines that the actual charging current of the auxiliary battery 130 exceeds the allowable charging current (step S203, YES), the process proceeds to step S204. Meanwhile, when the control unit 134 determines that the actual charging current of the auxiliary battery 130 does not exceed the allowable charging current (step S203, NO), the process proceeds to step S201.

### Step S204

The control unit 134 of the auxiliary battery 130 sets the allowable charging current of the auxiliary battery 130 to “0” (zero) (a third process). This setting is performed to re-check whether or not the charging control of the auxiliary battery 130 is operated normally after temporarily stopping supply to the auxiliary battery 130 from the high-voltage battery 110.

When the allowable charging current of the auxiliary battery 130 is set to “0”, the control unit 134 notifies the control unit 141 of the ECU 140 of the information regarding the allowable charging current. In response to this notification, the control unit 141 reduces the output voltage of the DC-DC converter (DDC) 120, and stops the current supply from the high-voltage battery 110 to the auxiliary battery 130 (the second process).

When the control unit 134 sets the allowable charging current of the auxiliary battery 130 to “0”, and the control unit 141 controls the DC-DC converter 120 according to the allowable charging current, the process proceeds to step S205.

### Step S205

The control unit 134 of the auxiliary battery 130 determines whether or not the actual charging current of the auxiliary battery 130 exceeds the allowable charging current continuously for a predetermined time. That is, the control unit 134 determines whether or not the charging current is continuously flowing to the auxiliary battery 130 continuously for a predetermined time even after the allowable charging current is set to “0”. This determination is made to define that an abnormality has occurred in the charging control of the auxiliary battery 130 based on the allowable charging current. Thus, the predetermined time is set to a time sufficient for defining that an abnormality has occurred in charging control.

When the control unit 134 determines that the actual charging current of the auxiliary battery 130 exceeds the allowable charging current continuously for a predetermined time (step S205, YES), the process proceeds to step S207. Meanwhile, when the control unit 134 determines that the actual charging current of the auxiliary battery 130 does not exceed the allowable charging current continuously for a predetermined time (step S205, NO), the process proceeds to step S206.

### Step S206

The control unit 134 of the auxiliary battery 130 determines whether or not the actual charging current of the auxiliary battery 130 is converged to the allowable charging current or less. That is, the control unit 134 determines whether or not the charging current of the auxiliary battery 130 is also reduced to reach zero in response to the setting of the allowable charging current to “0”.

When the control unit 134 determines that the actual charging current of the auxiliary battery 130 is converged to the allowable charging current or less (step S206, YES), the process proceeds to step S201. Meanwhile, when the control unit 134 determines that the actual charging current of the auxiliary battery 130 is not converged to the allowable charging current or less (step S206, NO), the process proceeds to step S203.

### Step S207

The control unit 134 of the auxiliary battery 130 determines that an abnormality (restriction violation abnormality) has occurred in the charging control of the auxiliary battery 130 based on the allowable charging current (a fourth process). Examples of the cause of the abnormality include a setting abnormality of the allowable charging current in the control unit 134, a communication abnormality between the control unit 134 and the control unit 141, a command value abnormality to the DC-DC converter 120 by the control unit 141, an operation abnormality of the DC-DC converter 120 based on the command value, and the like.

It is to be noted that, when the abnormality of the charging control is determined, it is desired to notify a driver or the like of the occurrence of the charging control abnormality via a meter device, an information display, or the like of the vehicle.

When the control unit 134 determines that an abnormality (restriction violation abnormality) has occurred in the charging control of the auxiliary battery 130 based on the allowable charging current, this auxiliary battery charging control is ended.

### Actions and Effects

As described above, with the control device according to one embodiment of the present disclosure, the allowable charging current of the auxiliary battery 130 is set based on the state of the vehicle and the state of the auxiliary battery 130, and the charging of the auxiliary battery 130 is controlled based on the set allowable charging current. Then, when the actual charging current of the auxiliary battery 130 exceeds the allowable charging current, the allowable charging current is reduced and reset, and, when the actual charging current exceeds the reset allowable charging current continuously for a predetermined time, it is determined that an abnormality has occurred in the charging control of the auxiliary battery 130.

With this control, the allowable charging current can be adjusted based on not only the state of the auxiliary battery 130 but also the state of the vehicle, and hence the occurrence of lithium deposition in the auxiliary battery 130 can be prevented even when the load 200 connected to the auxiliary battery 130 fluctuates variously according to the state of the vehicle.

One embodiment of the present disclosure has been described above, but the present disclosure can be regarded not only as the above-mentioned control device, but also as a method to be executed by a control device including a processor and a memory, a program for the method, a computer-readable non-transitory recording medium having the program stored therein, a vehicle having the control device mounted thereon, or the like.

The control device of the present disclosure can be used for, for example, a vehicle including a high-voltage battery and an auxiliary battery.

What is claimed is:

1. A control device configured to control an auxiliary battery mounted on a vehicle, the control device comprising:
a first processing unit setting an allowable charging current of the auxiliary battery based on a state of the vehicle and a state of the auxiliary battery; and
a second processing unit controlling charging of the auxiliary battery based on the allowable charging current.

2. The control device according to claim 1, further comprising:
a third processing unit reducing and resetting the allowable charging current when an actual charging current actually flowing through the auxiliary battery exceeds the allowable charging current; and
a fourth processing unit determining that an abnormality has occurred in charging control when the actual charging current exceeds the reset allowable charging current continuously for a predetermined time.

3. The control device according to claim 1, wherein:
the state of the auxiliary battery includes a temperature of the auxiliary battery and a capacity retention rate of the auxiliary battery; and
the first processing unit sets the allowable charging current according to the temperature of the auxiliary battery and the capacity retention rate of the auxiliary battery.

4. The control device according to claim 3, wherein:
the state of the vehicle includes whether or not the vehicle is parked; and
the first processing unit sets, in a case other than when the vehicle is parked, the allowable charging current to be smaller than a case in which the vehicle is parked.

5. A control device configured to control an auxiliary battery mounted on a vehicle, the control device comprising:
a first processor configured to set an allowable charging current of the auxiliary battery based on a state of the vehicle and a state of the auxiliary battery; and
a second processor configured to control charging of the auxiliary battery based on the allowable charging current.
